(19) United States
(12) Patent Application Publication
(10) Pub. No.: US 2025/0103685 A1
(43) Pub. Date: Mar. 27, 2025

(54) METADATA CHAIN OF TRUST

(71) Applicant: INTERNATIONAL BUSINESS MACHINES CORPORATION, ARMONK, NY (US)

(72) Inventors: Olena Woolf, Toronto (CA); Steven Woolf, Toronto (CA)

(21) Appl. No.: 18/472,431

(22) Filed: Sep. 22, 2023

(51) Int. Cl. G06F 21/10

(52) U.S. Cl. CPC G06F 21/1015

(57) ABSTRACT

A system may receive digital content from a first user and verify that the first user is an owner of the digital content. The system may also generate, based upon a request by the first user, a first proxy for a portion of the digital content granting access to the portion of the digital content to a second user, and generate, based upon a request by the second user, a second proxy granting access to a third user.

### BACKGROUND

Aspects of the present disclosure relate to metadata chain of trust, and more particular aspects relate to protecting sensitive metadata while allowing sharing of the associated data.

Distribution and accessibility of information both inside and outside of an organization are two aspects of sharing business data. Collaboration, informed decision-making, performance analysis, consumer insights, and supply chain management are all made easier by this technique A smooth and safe data sharing environment is made possible through the use of APIs, cloud computing, and data governance. This procedure includes collaborations with third parties and may result in chances to more effectively use data.

### BRIEF SUMMARY

The present disclosure provides a method, computer program product, and system of a metadata chain of trust. In some embodiments, the method includes receiving digital content from a first user, verifying that the first user is an owner of the digital content, generating, based upon a request by the first user, a first proxy for a portion of the digital content granting access to the portion of the digital content to a second user, and generating, based upon a request by the second user, a second proxy granting access to a third user.

Some embodiments of the present disclosure can also be implemented by a computer program product comprising a computer readable storage medium having program instructions embodied therewith, the program instructions executable by a processor to cause the processors to perform a method, the method comprising receiving digital content from a first user, verifying that the first user is an owner of the digital content, generating, based upon a request by the first user, a first proxy for a portion of the digital content granting access to the portion of the digital content to a second user, and generating, based upon a request by the second user, a second proxy granting access to a third user.

Some embodiments of the present disclosure can also be implemented by a system comprising a processor and a memory in communication with the processor, the memory containing program instructions that, when executed by the processor, are configured to cause the processor to perform a method, the method comprising receiving digital content from a first user, verifying that the first user is an owner of the digital content, generating, based upon a request by the first user, a first proxy for a portion of the digital content granting access to the portion of the digital content to a second user, and generating, based upon a request by the second user, a second proxy granting access to a third user.

### BRIEF DESCRIPTION OF THE DRAWINGS

FIG. 1 is a block diagram that illustrates an example computing environment, according to various embodiments of the present invention.

FIG. 2 is a flowchart that illustrates an example method of generating a metadata chain of trust, according to various embodiments of the present invention.

FIG. 3 is a block diagram that illustrates an example system for generating a metadata chain of trust, according to various embodiments of the present invention.

### DETAILED DESCRIPTION

Aspects of the present disclosure relate to building a metadata chain of trust. While the present disclosure is not necessarily limited to such applications, various aspects of the disclosure may be appreciated through a discussion of various examples using this context.

In some embodiments, a method includes receiving digital content from a first user. The computer-implemented method also includes verifying that the first user is an owner of the digital content. The method also includes generating, based upon a request by the first user, a first proxy for a portion of the digital content granting access to the portion of the digital content to a second user. The method also includes generating, based upon a request by the second user, a second proxy granting access to a third user. In some embodiments, the method provides a technical advantage over current methods, because the disclosed method allows a user to securely provide other users access to stored data without involving an administrator and keeping generated metadata contained.

One or more of the following features can be separable or optional from each other.

The method also includes validating through a chain of trust a right of the second user to generate a proxy. For example, allowing further users to generate proxies enables the controlled proliferation of data sharing without involvement of an administrator.

The method also includes that each proxy may grant access to multiple users. For example, allowing a proxy to grant access to multiple users speeds up processing and reduces storage requirements by having fewer proxies processed and stored.

The method also includes that multiple proxies may be generated at each chain level for the digital content and each proxy may be directed to only grant access to a part of the digital content. For example, providing multiple proxies at each level gives the technical improvement of specifically tailoring what access each user has.

The method also includes that the first proxy is directed to a first part of the digital content, and the second proxy is directed to a second part of the digital content which is a subset of the first part. For example, directing subsequent proxies to specific portions of a parent proxies data provides the technical advantage of limiting the access of users that are granted access by subsequent proxies. In some embodiments, the first proxy may be a superior proxy to a second or dependent proxy, where the access of the dependent proxy is allowed by the superior proxy. In the same way, the second proxy may then be a superior proxy to a third proxy where the access of the third proxy is dependent on the second or superior proxy.

The method also includes generating, based upon a request by the third user, a third proxy granting access to a fourth user. For example, having further proxies grant further users access demonstrates the technical advantage of continuing to grow a chain of trust.

The method also includes storing one or more data requests on an immutable ledger of a blockchain network. For example, storing the data request facilitated by the proxies gives the technical advantage of storing a record of any access on an immutable ledger.

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as processing code block 201 configured for protecting sensitive data with a metadata chain of trust. In addition to code block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 201, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

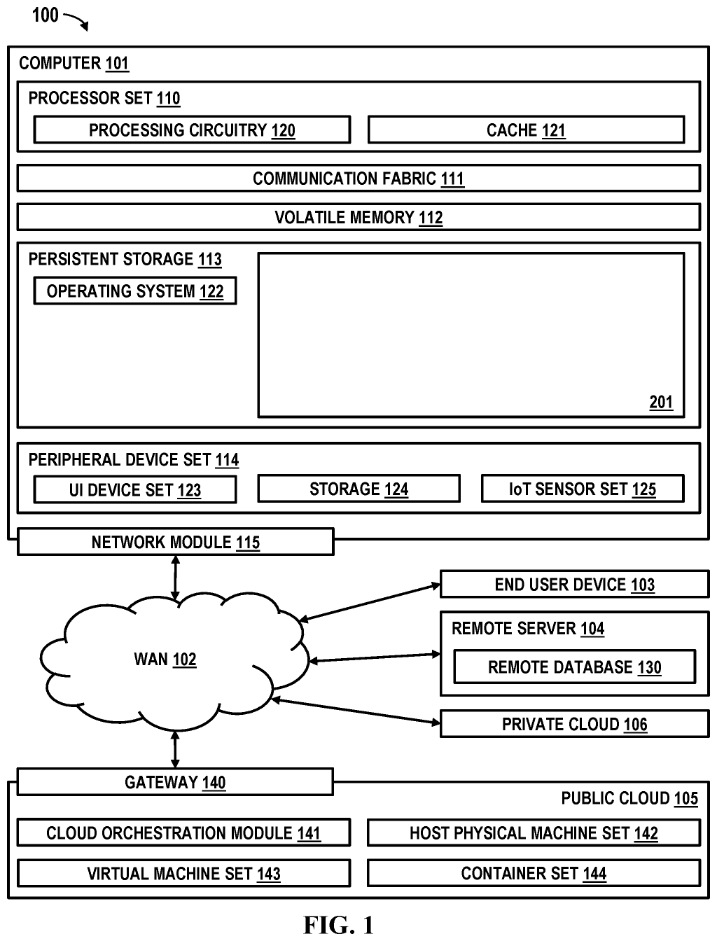

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 201 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some embodiment, a system, method, and computer program product are provided for facilitating users to share access to a digital content without having administrative access to a digital source where the digital content is stored.

In some embodiments, data fabric is a data management architecture that serves as an integrated layer (fabric) of data and connecting processes. In some instances, the term “fabric” may be used herein by way of example, but other ways of accessing and sharing data, such as data exchanges and data marketplaces may be used, and are to be considered within the scope of the term “fabric” herein. The fabric provides user with self-service access to data across all environments, including hybrid and multi-cloud platforms. In some instances, data fabric architecture comprises of a data catalog to capture metadata about data sources, a policy engine for data protection rules, and a data mesh that transparently connects the application to the data without being aware of the data's actual location. Although data fabric systems are described herein as an example, the methods and system in this disclosure may be used with other systems. In some instances, client-server architecture is a computing model in which the server hosts, delivers, and manages most of the resources and services requested by the client. In some instances, a client accessing data through a client-server architecture may be referred to as a client accessing data.

In some instances, a data catalog provides self-service by allowing data stewards (e.g., owners or controllers with rights to the data) to create digital content (e.g., data assets) by cataloging tables from source systems and data consumers to find data assets and gain access to the data tables.

Data fabric is an architecture that facilitates the end-to-end integration of various data pipelines and cloud environments through the use of intelligent and automated systems. Over the last decade, developments within hybrid cloud, artificial intelligence, the internet of things (IoT), and edge computing have led to the exponential growth of big data, creating even more complexity for enterprises to manage. This has made the unification and governance of data environments an increasing priority as this growth has created significant challenges, such as data silos, security risks, and general bottlenecks to decision making. Data management teams are addressing these challenges head on with data fabric solutions. They are leveraging them to unify their disparate data systems, embed governance, strengthen security and privacy measures, and provide more data accessibility to workers, particularly their business users.

Historically, an enterprise may have had different data platforms aligned to specific lines of business. For example, one might have an HR data platform, a supply chain data platform, and a customer data platform, which house data in different and separate environments despite potential overlaps. However, a data fabric can allow decision-makers to view this data more cohesively to better understand the customer lifecycle, making connections between data that didn't exist before. By closing these gaps in understanding of customers, products and processes, data fabrics are accelerating digital transformation and automation initiatives across businesses.

Data virtualization is one of the technologies that enables a data fabric approach. Rather than physically moving the data from various on-premises and cloud sources using the standard ETL (extract, transform, load) processes, a data virtualization tool connects to the different sources, integrating only the metadata required and creating a virtual data layer. This allows users to leverage the source data in real-time.

By leveraging data services and APIs, data fabrics pull together data from legacy systems, data lakes, data warehouses, SQL databases, and apps, providing a holistic view into system performance. In contrast to these individual data storage systems, leveraging data fabric aims to create more fluidity across data environments, attempting to counteract the problem of data gravity—i.e., the idea that data becomes more difficult to move as it grows in size. A data fabric abstracts away the technological complexities engaged for data movement, transformation, and integration, making all data available across the enterprise.

Data fabric architectures operate around the idea of loosely coupling data in platforms with applications that need it. Still, there isn't one single data architecture for a data fabric as different clients have different needs. The various number of cloud providers and data infrastructure implementations ensure variation across clients. However, clients utilizing this type of data framework exhibit commonalities across their architectures, which are unique to a data fabric.

However, access to sensitive metadata must be carefully protected since it enables direct access to data, bypassing data fabric data protection rules.

Current data protection rules, under both enforcement conventions such as allow everything author deny (AEAD) and deny everything author allow (DEAA), do not protect connection metadata.

There is a need for a self-service system for allowing access to digital contents. Current technology does not allow digital contents to be shared and cloned by users without involving administrators, or sharing the metadata access information. For example, current systems either need an administrator to approve all access, or they share metadata access information with other users.

Therefore, a system and method for establishing a clear chain of trust to secure access to data objects (e.g., digital content herein) without sharing sensitive metadata is provided. The disclosed system provides users with access to trusted proxies enabling the use of data fabric to read data (e.g., application ready data). In some embodiments, the self-service sharing of data is accomplished by chaining proxies into a verified chain of trust. In some embodiments, the method includes using a chain of trust to provide trusted digital certificates and tracing trusted transactions with an immutable digital ledger on a blockchain network.

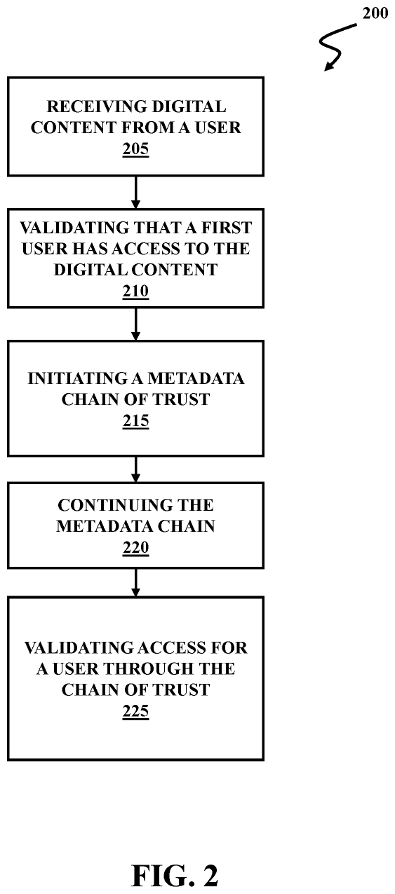

FIG. 2 depicts an example method 200 for processing code block 201 configured for protecting sensitive metadata with a metadata chain of trust. Operations of method 200 may be enacted by one or more computer systems, such as the system described in FIG. 1 above. In some instances, sensitive metadata is information (e.g., user identifiers) for allowing access to digital content (e.g., a data object).

Method 200 begins with operation 205 of receiving digital content from a user. In some embodiments, the digital content may have multiple parts and may be stored in a database (e.g., database 310 below).

In some instances, data catalogs contain metadata about the data stored in the database. In some instances, metadata attributes are grouped into “assets” that are related to each other, for most effective metadata management and retrieval. For example, metadata attributes that are used to gain access to digital content (such as DB/port/credentials) are grouped together as connection asset. Metadata attributes for table info are grouped into table info data asset, referencing a connection asset. Metadata attributes for view info are grouped into another data asset, also referencing a connection asset.

In some instances, access to asset metadata is protected by role-based access control. Role-Based Access Control (RBAC) is a security concept and method for managing access to resources within an organization's information systems. RBAC is designed to improve security, simplify administration, and ensure that users have appropriate access to data and functionality based on their role in the organization. In an RBAC system, access control is determined by the roles an individual has in the organization, rather than by assigning access rights to each individual user.

In some embodiments, access to source data is protected by both native database policies and data fabric data protection rules (“data protection rules” herein). In some instances, in order to manage permissions and enforce security standards, a database management system (DBMS) may include access control and security mechanisms that are native to the DBMS itself. In some embodiments, rules are constructed to offer a fine-grained level of control over data access and modification, guaranteeing that only users with the proper authorization can take certain actions on the database-stored data. In some instances, active database policies are particularly crucial for upholding data confidentiality, integrity, and regulatory compliance.

In some embodiments, data protection rules define attribute-based access control of data. In some embodiments, the system may create data protection rules to define how to protect sensitive data based on the identity of the user and properties or characteristics of the data. In some embodiments, a data protection rule is evaluated for enforcement when a user accesses an asset in a governed catalog. In some instances, enforcement of the rule can affect the appearance of the data and whether the data asset can be moved out of the catalog for use.

In some instances, data protection rules apply to data assets in governed catalogs, and under some conditions, in projects and data virtualization. Data protection rules are automatically enforced when a catalog member attempts to view or act on a data asset in a governed catalog to prevent unauthorized users from accessing sensitive data. However, if the user who is trying to access the asset in a catalog is the owner of the asset (by default, the user who created the asset), then unrestricted access may be granted by default.

In some instances, a data protection rule consists of criteria and an action block. Criteria identifies what data to control and can include who is requesting access to the data and the properties of the data asset. The criteria can consist of a number of predicates that are combined in a Boolean expression. In some instances, the predicates can include user attributes and asset properties, such as the data classes, classifications, tags, or business terms that are assigned to the asset. The action block specifies how to control the data. The action block can consist of binary actions, such as denying access to data, and data transformative actions, such as masking the data values in a column or filtering rows.

In some embodiments, data protection rules are evaluated per data asset to grant user access to table data. In some embodiments, rules are based on data asset attributes. In some embodiments, data protection rules do not protect connection metadata.

Method 200 continues with operation 210 of the system validating that a first user (by way of example only, user A herein) has access to the digital content. In some embodiments, the validating may be checking a registry associated with the digital content to determine that user A is an owner of the digital content. In some embodiments, the validating may be done when user A stores the digital content on the database. In some embodiments, the system may validate that user A has been granted access to share the digital content.

Method 200 continues with operation 215 of initiating a metadata chain of trust by generating a first metadata proxy (“proxy” herein). In some embodiments, a proxy (e.g., proxy A created by the system under the authority of user A) may indicate that access to all or parts of the digital content are granted to specified users. In some embodiments, users are identified through an identification system. For example, users may be identified through a username and password or other type of unique identifier system. In some embodiments, further linked proxies may be generated to expand the chain of trust. In some instances, metadata may be classified into two categories, sensitive and informational. In some instances, sensitive metadata includes connection credentials, API keys, host names, ports, etc. In some instances, informational metadata includes tables, views, columns, databases, etc. Another example of informational metadata that needs protection could be an SQL Query, URL, reporting dashboard, API, or data product (which is a grouping of several informational assets for specific use case). In some embodiments, data stewards create/update a connection asset with sensitive metadata in a catalog and create a data asset per table/file, referencing a sensitive connection asset. In some embodiments, data stewards are people that have access to digital content.

In some embodiments, a chain of trust is a chain of proxies that are used to verify data access rights to users. In some embodiments, a chain of trust can be implemented using techniques and technology as dictated by the data fabric architecture. In some instances, the GUIDs (Globally Unique Identifier) of trusted proxies may be stored with sensitive data. In some instance, the system may use a secure process for capturing GUIDs of a parent on proxy (e.g., Publish Application Programming Interface to clone proxies from Catalog to Project). In some instances, the system may use a workflow process to allow users to create a draft proxy (e.g., a subsequent proxy in the chain of trust) and have owners of the parent (e.g., a first proxy or a proxy above the draft proxy in the chain of trust) proxy approve the draft proxy before it is stored in the data catalog.

In some embodiments, a chain of trust under an AEAD system only registered owners may access the data (e.g., the original owners or owner registered by a proxy). In some embodiments, AEAD data stewards make a first proxy for a digital content, providing informational and sensitive metadata, such as shared data access credentials, for access of the digital content. In some embodiments, AEAD data stewards are owners of the digital content (e.g., in operation 210) and have the authority to invite other owners.

For example, an AEAD system is authorized, by a data steward, to create proxy A for a digital content, where proxy A is allowed to be publicly accessible by anyone in a catalog of registered users. In some embodiments, users B, C are assigned as owners in proxy A. In some embodiments, a GUID, of proxy A is stored as a “trusted” proxy the digital content.

In some embodiments, the AEAD chain of trust is configured to expand with an expanding list of users gaining access to the digital content by adding further proxies. In some embodiments, trust is verified by owners of referenced asset creating verified ownership through proxies in the chain of trust.

In some embodiments, a chain of trust under DEAA may grant ownership rights or discretionary access rights to users for the digital content. In some embodiments, a DEAA data steward may make a proxy which provides informational and sensitive metadata such as shared data access credentials. In some embodiments, DEAA data stewards may also create proxies. In some embodiments, under DEAA, metadata in a catalog is allowed to be publicly accessible by anyone in the Catalog. Under DEAA, a trusted proxy is used to assign users (for example, users B and C) as owners of the digital content. In some embodiments, non-sensitive metadata may be publicly accessible so users can learn about the existence of digital content they may want to gain access to. This is an aspect of self-services. To gain access with a chain of trust, a user may request permission from owners of the latest proxy (vs. going all the way to original owners of digital content). In some embodiments, under DEAA, owners may grant discretionary access to data (DAC) to other users (for example users E and F) through a not-trusted proxy. In some embodiments, trusted proxies grant ownership rights and not-trusted proxies grant DAC rights. In some embodiments, in a DEAA system, the data fabric verifies a user's DAC access to the digital content through the chain of trust. For example, DAC rights may include a not-trusted proxy and may include trusted proxies, depending on if the original owner granted the DAC access (no direct trusted proxies in the chain) or the user granting the DAC access was granted ownership rights in a trusted proxy (at least one trusted proxy in the chain). In some embodiments, a proxy uses sensitive metadata from the parent asset to gain access to data, where a proxy has a reference to the parent proxy.

In some embodiments, a proxy may be a type of intermediary that enables, facilitates, or provides data retrieval from a secure source. In some embodiments, a proxy may be a file type and configuration to suit the application needs. For example, a proxy may be configured to provide credentials from a parent proxy, credentials from a connection of a parent data asset, and or credentials from a parent connection asset. In some embodiments, a parent asset may also be a proxy to a parameter set asset. In some embodiments, a sensitive metadata asset, in addition to a “connection asset,” is used by extract, transform, and load (ETL) jobs/data flow jobs to reference sensitive metadata. A connection asset may be similar to the pattern of several data assets referencing the connection asset. In some embodiments, a proxy GUID is registered with the parent proxy to indicate trust.

In some embodiments, digital content may be divided into parts. For example, digital content may be divided into a first part and a second part. In some embodiments, each proxy may selectively give each user access to all of the digital content or a part of the digital content. For example, user A may initiate the creation of proxy A to give user B ownership access to all of the digital content and user C only ownership access to the second part of the digital content. In this example, user B could create a subsequent proxy giving ownership access for either the first part or the second part, but user C could only create a proxy giving ownership access to the second part of the digital content.

Method 200 continues with operation 220 of the system continuing the metadata chain by the creation of one or more additional proxies and amending an existing proxy to allow access to the additional proxies. Following the above example, since user C has access/ownership of the digital content, user C may command the system to create proxy B giving ownership to user D and user E. In some instances, new owners of digital content must be approved via the chain of trust.

Method 200 continues with operation 225 of the system validating access for a user through the chain of trust, where the chain of trust is comprised of one or more proxies. For example, the system may verify that user D has access to the digital content because trust is verified through the proxies in the chain of trust.

In some embodiments, the system may use a chain of trust to verify user access to a digital content through a chain of trusted proxies. In some embodiments, a successful verification for a user may be linked through a series of proxies in the chain of trust. For example, a system (this example is valid for AEAD or DEAA) has user A which is the owner of a first digital content. User A creates a first proxy giving ownership rights to user C and user D. User C creates a second proxy that gives ownership rights to the first digital content to user E. If user E requests data from the system, the system would verify that the first proxy, created by user C, gave access to user E and then that the first proxy gave access to user C. Thus, the access of user E is verified and the system grants user E access to the sensitive data. This is a simple example, but the chain of proxies may continue with users D and/or E creating further proxies to give other users access.

In some embodiments, an unsuccessful verification through a proxy not in the chain of trust may not result in granting access to a user. Following the previous example, ninth proxy grants user F access to a second digital content. If user F attempts to access the first digital content though the ninth proxy, no data on the first digital content would be returned since ninth proxy is not in the chain of trust for the first digital object.

In some embodiments, a DEAA system may verify that a user has discretionary access (DAC). In a DEAA system, users may create trusted proxies that give ownership or DAC or non-trusted proxies that only give DAC. Following the previous example, user C creates the second proxy to give ownership access to user E and DAC access to user G. Likewise, user D creates a third non-trusted proxy to give DAC access to user H. The DAC access can be verified through the chain of trust for both users G and H. The DAC access of user G is verified through trusted proxies, and the access of user D is verified because an owner (verified through the chain of trust) created the non-trusted proxy to give access to user D.

In some embodiments, each attempt to access the digital content through the chain of trust may be stored on a blockchain ledger. In some embodiments, the ledgers entries will include identification for the user trying to access the digital content, what content the user is trying to access, what proxies in the chain of trust were invoked, and what the outcome was for the validation though each proxy in the chain of trust.

In some embodiments, the method, system, and/or computer program product utilize a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records, and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments, a permissioned and/or a permission-less blockchain can be used. In a public or permission-less blockchain, anyone can participate without a specific identity (e.g., retaining anonymity). Public blockchains can involve native cryptocurrency and use consensus based on various protocols such as Proof of Work. On the other hand, a permissioned blockchain database provides secure interactions among a group of entities which share a common goal but which do not fully trust one another, such as businesses that exchange funds, goods, information, and the like.

Further, in some embodiments, the method, system, and/or computer program product can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The method, system, and/or computer program product can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain, while transactions which are not endorsed are disregarded.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log; it can therefore be regenerated from the chain at any time. The state database may automatically be recovered (or generated if needed) upon peer node startup and before transactions are accepted.

Blockchain is different from a traditional database in that blockchain is not a central storage, but rather a decentralized, immutable, and secure storage, where nodes may share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein.

In particular, the blockchain ledger data is immutable, and that provides for an efficient method for processing operations in blockchain networks. Also, use of the encryption in the blockchain provides security and builds trust. The smart contract manages the state of the asset to complete the life-cycle, thus specialized nodes may ensure that blockchain operations with anonymity requirements are able to securely submit operations to the blockchain network. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set. In other words, the blockchain inherent features provide for efficient implementation of processing a private transaction in a blockchain network.

One of the benefits of the example embodiments is that they improve the functionality of a computing system by implementing a method for processing a private transaction in a blockchain network. Through the blockchain system described herein, a computing system (or a processor in the computing system) can perform functionality for private transaction processing utilizing blockchain networks by providing access to capabilities such as distributed ledger, peers, encryption technologies, MSP, event handling, etc. Also, the blockchain enables creating a business network and making any users or organizations to on-board for participation. As such, the blockchain is not just a database. The blockchain comes with capabilities to create a network of users and on-board/off-board organizations to collaborate and execute service processes in the form of smart contracts.

Meanwhile, a traditional database may not be useful to implement the example embodiments because a traditional database does not bring all parties on the network, a traditional database does not create trusted collaboration, and a traditional database does not provide for an efficient method of securely and efficiently submitting operations. The traditional database does not provide for a tamper proof storage and does not provide for guaranteed valid transactions. Accordingly, the example embodiments provide for a specific solution to a problem in the arts/field of anonymously submitting operations in a blockchain network.

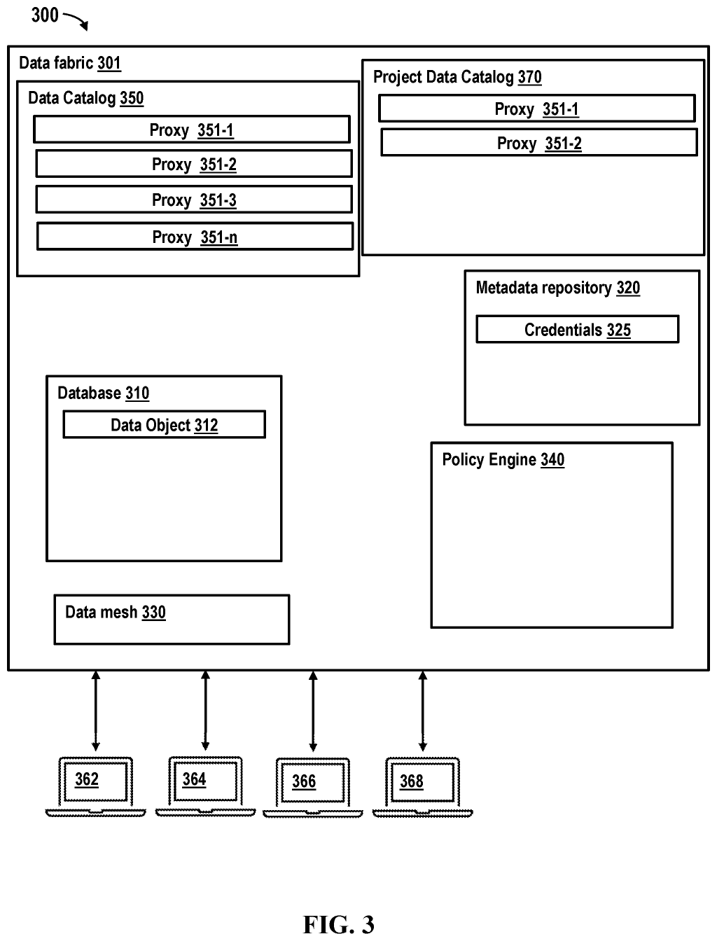

FIG. 3 depicts an example system 300 (e.g., a data fabric system) to control access to sensitive data as provided herein. In some embodiments, example data fabric 301 may contain database 310, metadata repository 320, data mesh 330, policy engine 340, and catalog 350. In some embodiments, system 300 may interact with multiple users such as user access 362, 364, 366, and 368.

In some embodiments, database 310 is a real or virtualized database repository that holds data. In some instances, access to it is secured by credentials. In some embodiments, database 310 may contain digital content 312. In some embodiments, access to database 310 is secured by credentials.

In some embodiments, metadata repository 320 is a real or virtualized database for holding metadata objects. In some embodiments, metadata repository 320 includes credentials 325 which may be used to access database 310.

In some embodiments, data mesh 330 is a decentralized system for managing data in database 310. In some embodiments, data mesh 330 governs access to data with policy enforcement schemes such as policy enforcement points (PEP).

In some embodiments, a policy engine 340 is a part of a data fabric system (such as system 300) controls the rules, regulations, and policies related to data within the data fabric environment. In some instances, a policy engine may be used to ensure that data sharing within a data fabric environment follows predefined guidelines, security measures, compliance requirements, and access controls. In some instances, the policy engine may help to maintain data quality, security, and governance across the data fabric environment.

In some embodiments, a catalog 350 is a metadata repository for assets that provides a logical grouping of assets. In some instances, the catalog 350 refers to a centralized repository or system that stores metadata and information about the various data assets within the data fabric environment.

In some embodiments, catalog 350 contains proxies 351-1, 351-2, 351-3 . . . 351-n, where 351-n represents multiple further proxies.

In some embodiments, project data catalog 370 may one or more proxies from data catalog 350 to limit access of some users to proxies that only belong to a specific project. For example, user D may be granted access to a project through proxy 351-1 and proxy 351-2 but does not need to have access to the metadata for any of the other proxies in data catalog 350. Therefore, user D may only be allowed to view the proxies copied to project data catalog 370.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory storing program instructions; and
a processor in communication with the memory, the processor being configured to execute the program instructions to perform processes comprising:
receiving digital content from a first user;
verifying that the first user is an owner of the digital content;
generating, based upon a request by the first user, a first proxy for a portion of the digital content granting access to the portion of the digital content to a second user; and
generating, based upon a request by the second user, a second proxy granting access to a third user.

2. The system of claim 1, wherein the memory stores further program instructions, and wherein the processor is configured to execute the further program instructions to perform the processes further comprising:
validating through a chain of trust a right of the second user to generate a proxy.

3. The system of claim 1, wherein each proxy is configured to grant access to multiple users.

4. The system of claim 1,
wherein multiple proxies are configured to be generated at each chain level for the digital content and each proxy is configured to be directed to only grant access to a part of the digital content; and
wherein a dependent proxy is on a lower chain level than a superior proxy.

5. The system of claim 4, wherein the first proxy is directed to a first part of the digital content, and the second proxy is directed to a second part of the digital content which is a subset of the first part.

6. The system of claim 1, wherein the memory stores further program instructions, and wherein the processor is configured to execute the further program instructions to perform the processes further comprising:
generating, based upon a request by the third user, a third proxy granting access to a fourth user.

7. The system of claim 1, wherein the memory stores further program instructions, and wherein the processor is configured to execute the further program instructions to perform the processes further comprising:
storing one or more data requests facilitated by the first proxy on an immutable ledger of a blockchain network.

8. A computer program product comprising a computer readable storage medium having program instructions embodied therewith, the program instructions executable by a processor to cause the processor to perform a method, the method comprising:
receiving digital content from a first user;
verifying that the first user is an owner of the digital content;
generating, based upon a request by the first user, a first proxy for a portion of the digital content granting access to the portion of the digital content to a second user; and
generating, based upon a request by the second user, a second proxy granting access to a third user.

9. The computer program product of claim 8, further comprising additional program instructions stored on the computer readable storage medium and configured to cause the processor to perform the method further comprising:
validating through a chain of trust a right of the second user to generate a proxy.

10. The computer program product of claim 8, wherein each proxy is configured to grant access to multiple users.

11. The computer program product of claim 8,
wherein multiple proxies are configured to be generated at each chain level for the digital content and each proxy is configured to be directed to only grant access to a part of the digital content; and
wherein a dependent proxy is on a lower chain level than a superior proxy.

12. The computer program product of claim 11, wherein the first proxy is directed to a first part of the digital content, and the second proxy is directed to a second part of the digital content which is a subset of the first part.

13. The computer program product of claim 8, further comprising additional program instructions stored on the computer readable storage medium and configured to cause the processor to perform the method further comprising:
generating, based upon a request by the third user, a third proxy granting access to a fourth user.

14. The computer program product of claim 8, further comprising additional program instructions stored on the computer readable storage medium and configured to cause the processor to perform the method further comprising:
storing one or more data requests facilitated by the first proxy on an immutable ledger of a blockchain network.

15. A method comprising, using a processor:
receiving digital content from a first user;
verifying that the first user is an owner of the digital content;
generating, based upon a request by the first user, a first proxy for a portion of the digital content granting access to the portion of the digital content to a second user; and
generating, based upon a request by the second user, a second proxy granting access to a third user.

16. The method of claim 15, further comprising:
validating through a chain of trust a right of the second user to generate a proxy.

17. The method of claim 15, wherein each proxy is configured to grant access to multiple users.

18. The method of claim 15,
wherein multiple proxies are configured to be generated at each chain level for the digital content and each proxy is configured to be directed to only grant access to a part of the digital content; and
wherein a dependent proxy is on a lower chain level than a superior proxy.

19. The method of claim 18, wherein the first proxy is directed to a first part of the digital content, and the second proxy is directed to a second part of the digital content which is a subset of the first part.

20. The method of claim 15, further comprising:
generating, based upon a request by the third user, a third proxy granting access to a fourth user.
